(19) United States
(12) Patent Application Publication
(10) Pub. No.: US 2026/0259766 A1
(43) Pub. Date: Sep. 3, 2026

(54) DETECTION OF MEANINGFUL CONTEXT CHANGES FOR ADAPTIVE CONTROL OF ELECTRONIC DEVICES

(71) Applicant: Arm Limited, Cambridge (GB)

(72) Inventors: Remy Pottier, Grenoble (FR); Vasileios Laganakos, Saffron Walden (GB); Nicholas John Cook, Kenilworth (GB); Diya Soubra, Nice (FR)

(21) Appl. No.: 19/659,928

(22) Filed: Apr. 27, 2026

Related U.S. Application Data
(63) Continuation of application No. PCT/GB2024/050701, filed on Mar. 15, 2024.

(30) Foreign Application Priority Data
Oct. 27, 2023 (EP) 23306870.9
Feb. 20, 2024 (EP) 24386017.8

(51) Int. Cl. G06F 9/48

(52) U.S. Cl. CPC G06F 9/485; G06F 2209/486

(57) ABSTRACT

A computer-implemented method and system are provided for controlling operation of one or more electronic devices based on detection of a meaningful context change in context data describing a human experience. Context data, including aspects such as actions and intents, is received from one or more devices and used to predict subsequent actions and intents associated with a task. A distributional representation generates latent states corresponding to the predicted aspects, and a predictor estimates next latent states. A comparison between predicted and actual latent states yields a distance metric used to identify a meaningful context change. The method distinguishes temporary variations from changes requiring adaptation of a machine learning model. In response, the system selectively updates or replaces the model and may control device operation, including switching devices on or off. This enables adaptive, context-aware control across connected devices while maintaining stability against transient changes.

### CROSS-REFERENCE TO RELATED APPLICATIONS

This application is a continuation of International Application No. PCT/GB 2024/050701, filed Mar. 15, 2024, which claims the benefit of European Patent Application No. 23306870.9, filed Oct. 27, 2023, and European Patent Application No. 24386017.8, filed Feb. 20, 2024, which are hereby incorporated by reference in their entirety.

### BACKGROUND

Machine learning and other artificial intelligence technologies continue to be developed to solve a variety of different problems. Machine learning is a field of computer science using statistical algorithms that can learn from data. The machine learning models can be high-level models that utilize deep learning or can use various neural networks that are trained using a set of observations. The models created by machine learning and other artificial intelligence technologies can be used to automate tasks, such as those performed by smart devices.

Smart devices can refer to electronic devices that interconnect to other devices or networks via different wireless protocols and can operate to some extent interactively and autonomously. These devices are used by humans to assist with everyday tasks and decision making. However, devices such as smart glasses and other IoT (Internet of Things) devices have limited computing and storage capability and thus can only run a limited amount of use cases. In order to optimize tasks and decision making, perform a larger range of tasks, and generally provide better assistance to the person, smart devices can run generative artificial intelligence models that use machine learning alone or in ambient collaborative scenarios. However, uploading different machine learning models to these devices to perform new tasks can be time consuming and put a drain on the device battery. As a result, the devices can fail to deliver a good quality of experience if not well managed.

### BRIEF SUMMARY

A method and a system that detects a meaningful context changes for adaptive control of electronic devices is described herein. The described method and context change system, based on collected data from one or more electronic devices, can detect and understand user intentions to predict an upcoming action, or sequence of actions, and intent. Utilizing the predicted actions and intent, the method and system can determine when a meaningful change of context has occurred. Subsequently, the context change system can direct the electronic devices to operate so that they can act ambiently and autonomously on the human's behalf to support a real-life experience.

The electronic devices, e.g., smart devices, referenced herein can run machine learning models. Machine learning is a field of computer science using statistical algorithms that can learn from data. The machine learning models can be high-level models that utilize deep learning or can use various neural networks that are trained using a set of observations.

According to certain applications of the described improved detection of behavior from multi-variable data techniques, a method and a context change system that detects a meaningful change of context in a human experience utilizing one or more electronic devices are provided. The described method and context change system, based on collected data from one or more electronic devices, can detect and understand user intentions to predict an upcoming action, or sequence of actions, and intent. Utilizing the predicted actions and intent, the method and system can determine when a meaningful change of context has occurred. Subsequently, the context change system can direct the electronic devices to operate so that they can act ambiently and autonomously on the human's behalf to support a real-life experience. For example, a meaningful change in context can result in a machine learning model swap.

According to an embodiment, a computer-implemented method is provided that can detect a meaningful context change in a human experience. The method includes the steps of: receiving context data from one or more electronic devices, the context data describing aspects of a human experience, wherein the aspects comprise an action and an intent; predicting a next action and a next intent based on the context data; generating, by a distributional representation, for the predicted next action, the predicted next intent and one or more further aspects, a corresponding latent first state; predicting, by a predictor, a next value of the latent first state for each latent first state; comparing a latent next state and the predicted next value of the latent first state for each latent first state by determining a distance between the latent next state and the predicted next value of the latent first state; and determining a meaningful context change in the human experience when the distance is greater than a threshold.

According to another embodiment, a context change system is provided. The context change system includes a forecaster that applies a short term forecast model to context data received from one or more electronic devices to predict a next action and a next intent from the context data, the context data describing aspects of the human experience wherein the aspects include the next action and the predicted next intent; a first variational autoencoder that receives prediction values output from the short term forecast model and generates a latent first state of each aspect; a predictor that receives output of the first variational autoencoder wherein the predictor applies a high-level model to the latent first state of each aspect to predict a next value of the latent first state; a compatibility detector that compares the predicted next value of the latent first state and a latent next state to determine a distance between the latent next state and the predicted next value of the latent first state; and a context change detector that receives output of the predictor to detect a meaningful context change when the distance is greater than a threshold.

In certain embodiments, the method and system can utilize non-homogeneous telemetry data coming from various electronic devices and technological generations. Energy-based models can consume this non-homogeneous data, adaptively learning to project the data down into low dimensional manifolds that represent ‘concepts’in the data itself. The properties of energy-based models can be leveraged as a flexible ensembling technique as multiple high-level models can be combined to produce better results with the encoded non-homogeneous data. Thus, energy-based models are leveraged to build flexible models that work across heterogeneous telemetry sources over multiple technological generations relative to some machine learned concepts. In this way, the high-level models can be tuned without having to fully update them.

Furthermore, detected abnormal behaviors can be reasoned on and depending on the determined reasoning, can be fed back as latent variables to tune the high-level models used in the behavior analysis system. Importantly, these ‘flexible’ inference engines can be deployed to new devices with some new or redacted telemetry channels and still perform admirably as long as the non-homogeneous data continues to map to recognized concepts.

According to another embodiment, a behavior analysis system can include an variational autoencoder that generates a latent first state of telemetry data, wherein the telemetry data is collected from an electronic device and includes a first state and a next state that occurs after the first state, a predictor that receives output of the variational autoencoder wherein the predictor applies a high level model to the latent first state to predict a next value of the latent first state, compatibility detector that compares the predicted next value of the latent first state and a latent next state to determine a distance between the latent next state and the predicted next value of the encoded next state, and a behavioral detector that receives output of the compatibility detector.

In some aspects, a computer-implemented method is described for controlling operation of one or more electronic devices based on detection of to detect a meaningful context change in context data describing a human experience. The context data can include data collected by the one or more electronic devices during performance of a task involving a series of steps. The method can include: receiving context data from one or more electronic devices, the context data describing aspects of the a human experience, wherein the aspects include an action and an intent; predicting a next action and a next intent related to the task based on the context data; generating, by a distributional representation, for the predicted next action, the predicted next intent and one or more further aspects, a corresponding latent first state; predicting, by a predictor, a next value of the latent first state for each latent first state; comparing a latent next state and the predicted next value of the latent first state for each latent first state by determining a distance between the latent next state and the predicted next value of the latent first state; determining a meaningful context change in the human experience performance of the task when the distance is greater than a threshold, wherein the meaningful context change distinguishes a temporary change of intent and context from a change of intent and context for which a machine learning model running on at least one of the electronic devices is to be changed; and, in response to determining the meaningful context change, changing a machine learning model running on at least one of the electronic devices.

In some aspects, a system to detect a meaningful context change in a human experience is disclosed that includes: one or more processing units; a memory; and interface circuitry, wherein the system is structured as: a short term forecast model that predicts a next action and a next intent from context data received from one or more electronic devices, the context data describing aspects of the human experience wherein the aspects include the next action and the predicted next intent; a first variational autoencoder that receives prediction values output from the short term forecast model and generates a latent first state of each aspect; a predictor that receives output of the first variational autoencoder, wherein the predictor applies a high-level model to the latent first state of each aspect to predict a next value of the latent first state; a compatibility detector that compares the predicted next value of the latent first state and a latent next state to determine a distance between the latent next state and the predicted next value of the latent first state; and a context change detector that receives output of the predictor to detect a meaningful context change when the distance is greater than a threshold, wherein the meaningful context change distinguishes a temporary change of intent and context from a change of intent and context for which a machine learning model is to be changed.

In some aspects, a non-transitory computer-readable medium storing instructions is disclosed that, when stored instructions are executed by one or more processors, cause the one or more processors to perform a method or process as defined herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a process flow for improved detection of behavior from multi-variable data.

FIG. 2 illustrates an example smart home environment that includes a network of electronic devices.

FIG. 3 illustrates a block diagram of an example electronic device.

FIG. 4 illustrates an example real life scenario in the smart home environment of FIG. 2.

FIG. 5 illustrates an example implementation of a context change system architecture.

FIG. 6 illustrates a process flow of a method to detect a meaningful context change.

FIG. 7 illustrates a simplified view of an IC with various circuit blocks.

FIG. 8 illustrates a first example implementation of a behavior analysis system architecture.

FIG. 9 illustrates a second example implementation of a behavior analysis system architecture.

FIG. 10 illustrates a further example implementation of a behavior analysis system architecture.

FIG. 11 illustrates a process flow of a computer implemented method to detect abnormal behavior of an electronic device in accordance with one embodiment.

### DETAILED DESCRIPTION

A method and a context change system that detects a meaningful content changes for adaptive control of electronic devices is described herein. The described method and context change system, based on collected data from one or more electronic devices, can detect and understand user intentions to predict an upcoming action, or sequence of actions, and intent. Utilizing a predicted action(s) and intent, the method and system can determine when a meaningful change of context has occurred. Subsequently, the context change system can direct the electronic devices to operate so that they can act ambiently and autonomously on the human's behalf to support a real-life experience.

Smart devices can be connected to collaborate for support of a human life experience using ambient intelligence which can proactively and autonomously respond to human presence while operating in the background, i.e., ambiently. For example, if a person is standing near window and issues a command to open the window, connected smart devices in the presence of the person, such as a smart speaker and a camera, can determine which window the person desires open by determining which window the person is standing next to and which way the person is looking. Then, the smart speaker can direct a motor operating the window to open. Thus, the smart devices have determined the human's intent, e.g., open the window, from context data collected.

Sometimes, when a person is performing a task involving a series of steps, the person's intent and context can change. Intent refers to the person's desired outcome or purpose while the context is the circumstances surrounding the intent and against which intent can be fully understood and assessed. When a change of context occurs, e.g., a person baking a cake receives a call to pick up his child at school, the ML model used by the connected device(s) may need to change. However, a distinction between a temporary change of intent and context, and a more permanent change, e.g., a meaningful change, in context and intent needs to be made in order to determine whether the ML model running on one or more smart devices participating to deliver the experience needs to change. Thus, a context change detector that can detect a meaningful context change in which the ML model running needs to change for one or more of the connected electronic devices is desired.

In an implementation, the context change detector can include analytics processing circuitry that receives context data relating to a human experience from the one or more devices. The analytics processing circuitry can exist on one or more of the devices or the analytics processing circuitry can operate independent of the one or more devices. Components of the analytics processing circuitry can include a processing unit such as a microprocessor or a component of a microcontroller such as a memory protection unit (MPU). In some cases, the analytics processing circuitry is ‘virtual circuitry’ such that the method is executed in a cloud environment.

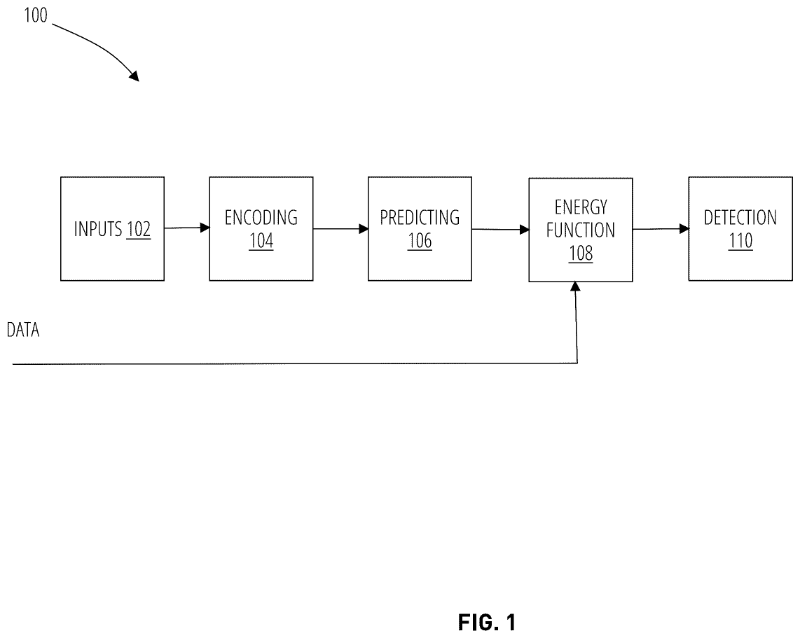

FIG. 1 illustrates a process flow for improved detection of behavior from multi-variable data. The process flow enables an evaluation of the degree of compatibility between more than one variable. Referring to FIG. 1, process flow 100 begins with inputs 102, in a form of data. Inputs 102 flow into an encoding 104 stage where encoders are configured to look for patterns in the inputs 102. The predicting 106 stage utilizes predictors to predict the next set of inputs. An energy function 108 compares the predicted next set of inputs with data to determine if the predicted next set of inputs are compatible with one another or not. A detection 110 block receives the comparison and uses the comparison to detect that a certain behavior has occurred.

According to certain applications of the improved detection of behavior from multi-variable data described with respect to FIG. 1, a method and a context change system that detects a meaningful change of context in a human experience utilizing one or more electronic devices is described herein. The described method and context change system, based on collected data from one or more electronic devices, can detect and understand user intentions to predict an upcoming action, or sequence of actions, and intent. Utilizing a predicted action(s) and intent, the method and system can determine when a meaningful change of context has occurred. Subsequently, the context change system can direct the electronic devices to operate so that they can act ambiently and autonomously on the human's behalf to support a real-life experience.

Smart devices are electronic devices that can be connected to other devices or networks via different wireless protocols and can operate to some extent interactively and autonomously. These devices are used by humans to assist with everyday tasks and decision making. However, devices such as smart glasses and other IoT (Internet of Things) devices have limited computing and storage capability and thus can only run a limited amount of use cases. In order to optimize tasks and decision making, perform a larger range of tasks, and generally provide better assistance to the person, smart devices can run generative artificial intelligence (AI) models that use machine learning (ML) alone or in ambient collaborative scenarios. However, uploading different ML models to these devices to perform new tasks can be time consuming and put a drain on the device battery. As a result, the devices can fail to deliver a good quality of experience if not well managed.

In some cases, smart devices are connected to collaborate for support of a human life experience using ambient intelligence which can proactively and autonomously respond to human presence while operating in the background, i.e., ambiently. For example, if a person is standing near window and issues a command to open the window, connected smart devices in the presence of the person, such as a smart speaker and a camera, can determine which window the person desires open by determining which window the person is standing next to and which way the person is looking. Then, the smart speaker can direct a motor operating the window to open. Thus, the smart devices have determined the human's intent, e.g., open the window, from context data collected.

Sometimes, when a person is performing a task involving a series of steps, the person's intent and context can change. Intent refers to the person's desired outcome or purpose while the context is the circumstances surrounding the intent and against which intent can be fully understood and assessed. When a change of context occurs, e.g., a person baking a cake receives a call to pick up his child at school, the ML model used by the connected device(s) may need to change. However, a distinction between a temporary change of intent and context, and a more permanent change, e.g., a meaningful change, in context and intent needs to be made in order to determine whether the ML model running on one or more smart devices participating to deliver the experience needs to change. Thus, a context change detector that can detect a meaningful context change in which the ML model running needs to change for one or more of the connected electronic devices is desired.

In an implementation, the context change detector can include analytics processing circuitry that receives context data relating to a human experience from the one or more devices. The analytics processing circuitry can exist on one or more of the devices or the analytics processing circuitry can operate independent of the one or more devices. Components of the analytics processing circuitry can include a processing unit such as a microprocessor or a component of a microcontroller such as a memory protection unit (MPU). In some cases, the analytics processing circuitry is ‘virtual circuitry’ such that the method is executed in a cloud environment on one or more host computing systems.

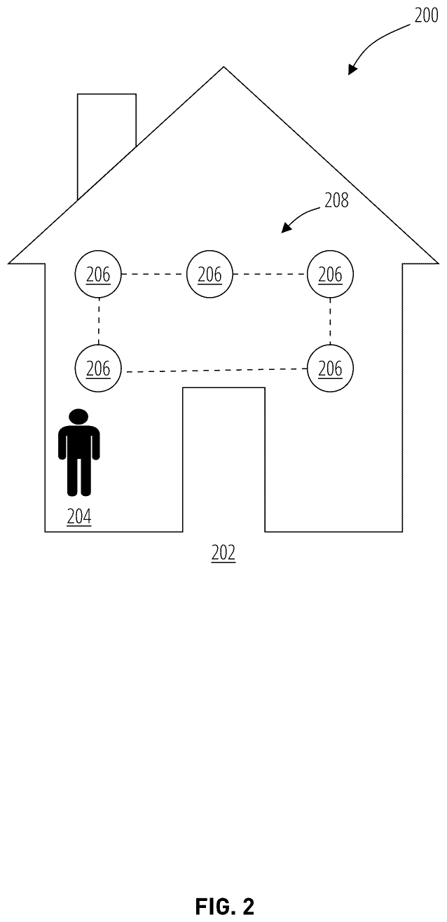

FIG. 2 illustrates an example smart home environment that includes a network of electronic devices. Referring to FIG. 2, a smart home environment 200 includes a home structure 202 and one or more electronic devices 206 connected in a network 208 within the home structure 202. While the home structure 202 can be a single residential structure, the home structure 202 can also be a care facility, a long-term hotel, or an apartment, for example. The electronic devices 206 can include ambient devices, e.g., a smart speaker, and personal devices, e.g., a smart phone, that collect data relating to a person 204 in the home structure 202 or the environment in which the person 204 is present. The network 208 of electronic devices can be connected within the home structure 202. In some cases, one or more of the electronic devices 206 of the network 208 can exist outside of the home structure 202 but coupled to one or more electronic devices 206 within the home structure 202.

The electronic devices 206 can include smart, multi-sensing electronic devices that can be connected in a network that communicates with one another and/or with a central server or cloud-computing system to provide human assistance. The electronic devices 206 can include directly observable devices that collect data and context from the human's environment. The data and context gathered from the human's environment can include physical characteristics such as temperature, location, sounds, images, activity level, as well as social data. Directly observable devices can include sensors, IoT (Internet of Things) devices, wearable devices such as smart glasses, and personal devices such as smart phones. In other cases, the electronic devices 206 can include cognitive devices that collect human cognitive data that may not be directly observable. The cognitive data can include the human's attention, inner state, emotion, and intention. Cognitive devices can include cognitive sensors such as behavioral voice assistants, behavioral cameras, chemical and biological sensors, and sensors that take input from a brain/nerve computer interface.

The electronic devices 206 can be connected in a mesh network in which they can communicate with one another. Some of the network-connected smart devices in the smart home environment 200 can be battery powered while other devices can have a reliable source of power such as by connecting to wiring in the home structure 202. Some of the electronic devices 206 can be equipped to communicate wirelessly utilizing any wireless protocol or manner to facilitate bidirectional communication with any of a variety of other devices in the smart home environment 200 as well as with the central server or cloud-computing system. In other cases, the network-connected smart devices that are battery powered can also communicate using wireless protocols but may be incapable of bidirectional communication.

While a smart home environment is shown, it is for exemplary purposes only, other environments utilizing connected devices can also be the environment in which the proposed method and system operates. For example, the proposed methods and systems can be utilized in urban environments such as smart cities which use a connected infrastructure that includes traffic lights, smart signage and public transportation that adapts to real-time conditions and provides relevant information to the public.

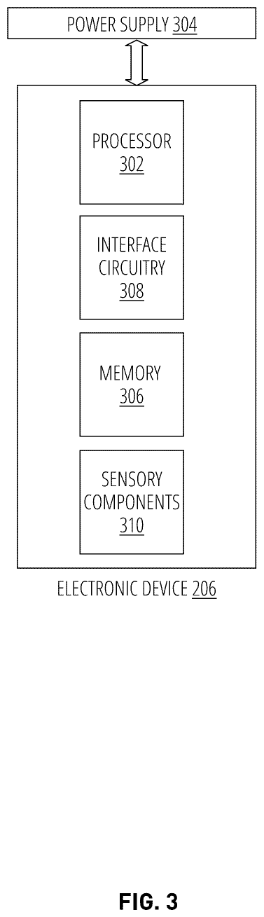

FIG. 3 illustrates a block diagram of an example electronic device. Even though electronic devices 206 connected in a network 208 of a smart home environment 200, or any other smart environment, can have a variety of different capabilities and limitations, they can all be thought of as sharing common characteristics in that each includes a communications portion which may implement several standards, a power source, and a processing unit which can coordinate the communications with an application by means of an operating system. The processing unit 302 can also run a machine learning (ML) model stored in a memory 306 of the device. Referring to FIG. 3, an electronic device 206, such as one of the electronic devices 206 connected in network 208 of FIG. 2 can include a processing unit 302, interface circuitry 308 for communication outside the device (e.g., with other electronic device(s) and/or remote computing systems), memory 306, and power supply 304. In some cases, the electronic device 206 can include one or more sensory components 310 such as a camera or a microphone. Context data regarding a human experience can be collected by the electronic device 206 via the sensory components 310.

Determining that a human intent and the context surrounding the intent has changed in a meaningful way, utilizing the ML models running on one or more of electronic devices 206, involves taking the data collected by the electronic devices 206, determining the human intent and context surrounding the human intent, and predicting one or more next actions in the human experience. As the data is collected by the electronic devices 206, the context change detector determines if the human is still performing the predicted actions in accordance with the determined human intent. When the performed actions deviate from the predicted actions, a determination can be made whether or not the actions deviate enough, e.g., a meaningful context change, such that the human's intent has changed.

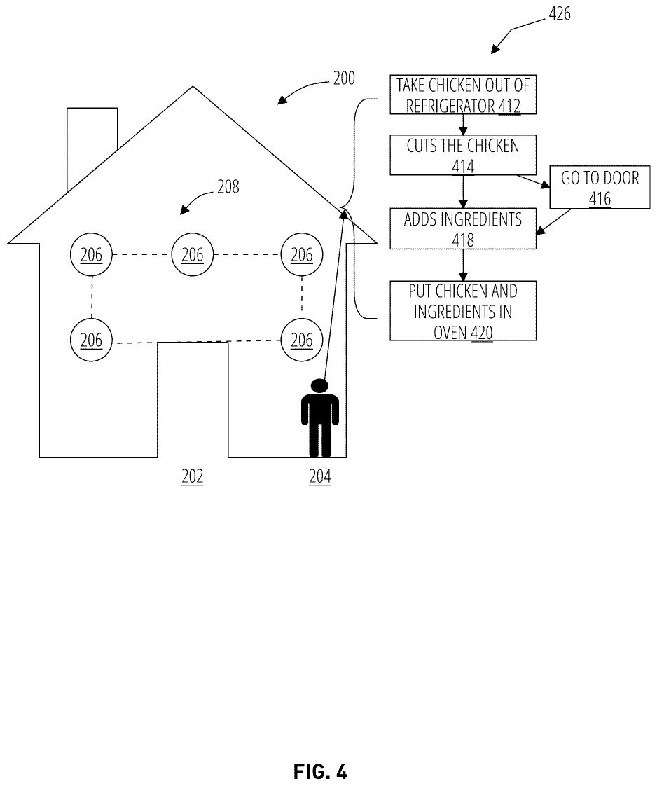

FIG. 4 illustrates an example real life scenario in the smart home environment of FIG. 2. In the illustrated cooking scenario 426, a person is cooking at home in the smart home environment 200. Many of the appliances in the kitchen are smart devices, e.g., electronic devices 206, that include sensors that can detect objects or actions occurring in the kitchen. For example, a sensor within the refrigerator can detect an object such as a cooking ingredient in the refrigerator. A camera having a field of view of the kitchen detects motion within the kitchen. A smart speaker detects the person's speech which places the person in the kitchen. The person takes chicken out of the refrigerator (412). Thus, it can be determined from the data collected by the electronic devices 206 that user's intent is to cook a meal in which the context includes the human cooking the meal at home in the kitchen utilizing the chicken.

A cloud computing system running an LLM (large language model) to which the electronic devices 206 in the home structure 202 communicate, for example, can deploy different ML models to the different appliances, e.g., smart electronic devices 206, in the kitchen. An LLM is a trained deep-learning ML model that can understand and generate text in a fashion that humans can read and understand. In this scenario, when the person takes chicken from the refrigerator (412), the cloud LLM resets the ML model in the smart refrigerator for chicken recipes using vegetables in the refrigerator. The person cooking asks others in the home what they would like for dinner. The others reply Italian food. The cloud computing system resets the ML model in the smart refrigerator for Italian recipes that the others have liked in the past, e.g., the ML model has learned what the humans in the house have liked and presents these recipes to the person. Now, if something in the context of this scenario changes in a meaningful way, e.g., the person has to stop cooking to pick up a child at school, the ML models that the cloud computing system deployed to the smart devices in the kitchen need to change for the new scenario. The proposed context change system can determine when a change in context is meaningful in order to trigger the change of ML models deployed to the electronic devices 206. Thus, thresholds for triggering a model change are based on activities that occur in the smart home environment 200, for example, by the person.

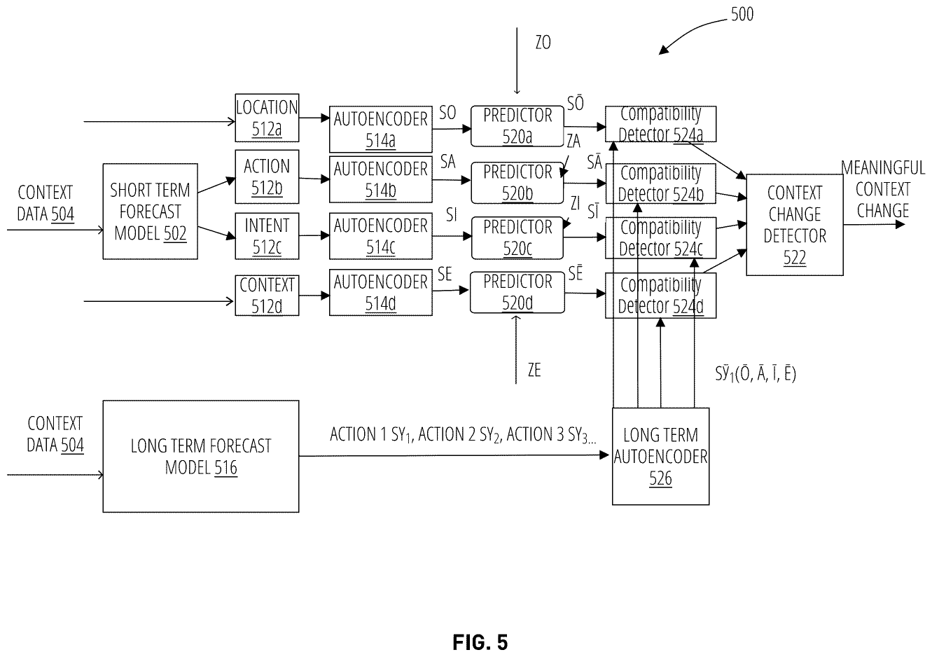

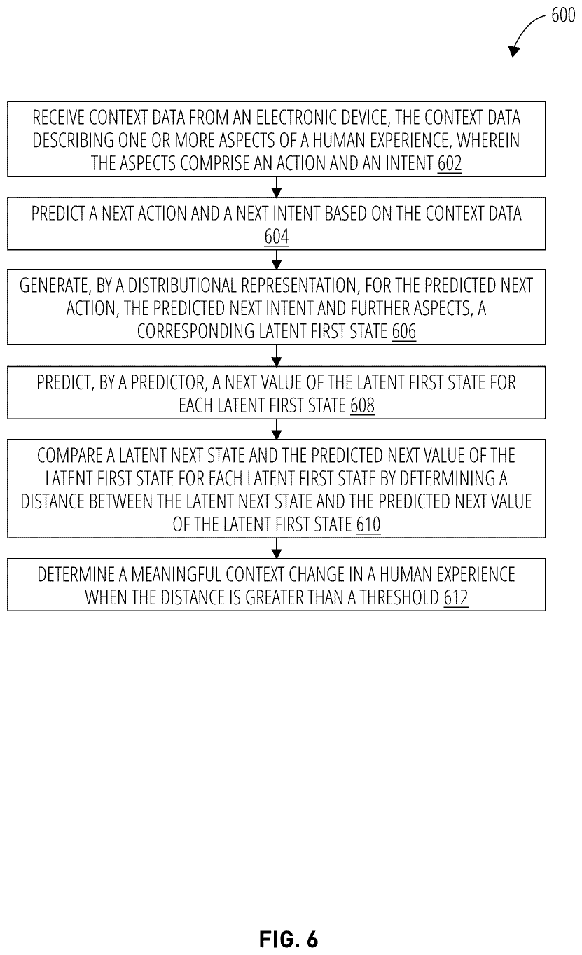

FIG. 5 illustrates an example implementation of a context change system architecture and FIG. 6 illustrates a process flow of a method to detect a meaningful change of context in a human experience.

Referring to FIG. 5, a context change system architecture 500 can be implemented at any electronic device in smart home environment 200 and can include a short term forecast model 502, one or more variational autoencoders 514a, 514b, 514c, 514d, 526, a long term forecast model 516, one or more predictors 520a, 520b, 520c, 520d, one or more compatibility detectors 524a, 524b, 524c, 524d, and a context change detector 522. The various components in the context change system architecture 500 can be implemented on an electronic device having one or more processing units and other circuitry that can perform the described operations through instructions stored in memory of the electronic device along with any hardware implemented logic (e.g., for acceleration). In some cases, the electronic device is one of the electronic devices 206 of FIG. 2 which can be embodied as shown in FIG. 3. In addition, although reference may be made to a model receiving inputs and providing outputs, it should be understood that it is the model executing on one or more processing units that performs the operations carried out by the model to generate the outputs.

Context data 504 collected by the one or more electronic devices 206, e.g., personal and ambient devices in the smart home environment 200, is input into the short term forecast model 502. The context data 504 can include physical characteristics of the smart home environment 200, social data, and human cognitive data as described previously. The short term forecast model 502 takes in the context data 504 including a human action and a location detected by the one or more electronic devices 206. In addition, a human intent, e.g., what the person is attempting to accomplish, can be inferred from the context data 504 by the short term forecast model 502. A context associated with the intent can also be inferred from the context data 504 by the short term forecast model 502.

Utilizing the context data 504, the short term forecast model 502 can predict the next active object along with the next action corresponding to the next active object at a future time. In addition, the short term forecast model 502 can predict human intent. Returning to our cooking scenario in FIG. 4, in the sequence of actions for making a dinner, because a camera notices the person 204 taking the chicken out of the refrigerator (412), the short term forecast model 502 can predict that the person will pick up a knife such that the knife is the next active object and thus predicts the next action corresponding to the knife to be cutting the chicken (414) in the next few seconds.

The short term forecast model 502 can then output the predicted next action 512b and the predicted intent 512c as aspects of the human experience as shown in FIG. 5. The predicted intent 512c can be, for example, to make dinner. The context is inferred from the context data 504, which in this example is cooking. Other factors can also be taken into account when determining the context such as the time of day and other events occurring surrounding the cooking event. While four aspects, e.g., location, action, intent, and context, of a human experience are shown, more or fewer aspects can be utilized. Each aspect exists in a first state. Each aspect will then be input into a corresponding variational autoencoder. Each variational autoencoder, autoencoder 514a, autoencoder 514b, autoencoder 514c, autoencoder 514d receives the output of the short term forecast model 502. In some cases, one variational autoencoder can be utilized to encode each of the input aspects.

Variational autoencoders include a type of unsupervised generative learning technique used in machine learning and are capable of finding ‘normalized’ latent space representations in raw input data using neural networks. By reducing the dimensionality of the input data, variational autoencoders can find latent space representations. The variational autoencoders in context change system architecture 500, autoencoder 514a, autoencoder 514b, autoencoder 514c, autoencoder 514d and long term autoencoder 526, are deterministic variational autoencoders that take in input data, e.g., the aspects of the human experience, and output a latent representation (So, Sa, Si, Se and Sy, respectively) of the input data. While variational autoencoders are referenced throughout the disclosure, they are one example of generating a distributional representation of a latent state. Other energy-based methods can be used to generate a distributional representation of a latent state.

Each variational autoencoder 514a, 514b, 514c, and 514d, includes a high-level model that has been trained to identify certain patterns of an aspect of the collected context data 504. For example, if one of the aspects is location, the high-level model can be trained to detect if the person is still in the kitchen. Variational autoencoders 514a, 514b, 514c, 514d can each generate as its output a latent first state (So, Sa, Si, and Se, respectively).

Each predictor 520a, 520b, 520c, 520d is coupled to the output of each corresponding variational autoencoder 514a, 514b, 514c, 514d to receive as an input the latent first state (So, Sa, Si, and Se). Each predictor is trained to detect, or predict, the next state of the latent first state and can include one or more processors (or processing units) and storage to support artificial intelligence, machine learning, and/or deep learning processes. Each predictor 520a, 520b, 520c, and 520d includes a high-level machine learning model that has been trained on potential future latent states of the latent first state (So, Sa, Si, and Se). For example, there may be two potential future states or many potential future states which the model is trained to predict. The high-level machine learning model can be applied to the latent first state (So, Sa, Si, and Se) to generate as an output a next value of the latent first state (Sō, SāSī, Sē).

In some cases, the high-level machine learning model of each predictor includes a latent variable energy-based prediction model. Energy-based models are generative models that can learn an underlying data distribution by analyzing a dataset. The latent variable energy-based model of the predictor predicts the next value of the latent first state. In order to do this prediction, the predictor can utilize a latent variable Zₙ that provides auxiliary information that cannot be extracted from the latent first state (So, Sa, Si, and Se). For the high-level machine learning model of the predictor, the latent variable Zₙ can represent a possible future state when the latent first state has multiple possible futures. Then, when a change occurs, e.g., an unpredicted action, or sequence of unpredicted actions, the predictor would not be able to properly predict the next value of the latent first state (Sō, Sā, Sī, Sē). The latent variable Zₙ enables the latent variable energy-based model to handle multiple predictions and is identified during the training phase. For example, two plausible future locations for person 204 may be that he/she changes location from the kitchen to the bathroom or changes location from the kitchen to the basement. These location changes could potentially be alright for maintaining our scenario. To avoid having to train the predictor with a generative model, the latent variable Zₙ is defined by running an ‘argmin’ function such as ̌z=argminz∈Z Ew (x, y, z). Thus, in other words, the energy based latent variable model can detect a change across the corresponding aspect, e.g., is this a predicted next action/predicted intent?

A long term forecast model 516 also takes in the context data 504 including human action and a location detected by the one or more electronic devices 206. In addition, a human intent, e.g., what is the person attempting to accomplish, can be inferred from the context data 504 by the long term forecast model 516. Likewise, the context can also be determined by the long term forecast model 516 from the context data 504.

In contrast to the short term forecast model 502, the long term forecast model 516 predicts a sequence (more than one) of next actions at times in the future. Referring back to the cooking scenario of FIG. 4, after cutting up the chicken (414), the long term forecast model 516 may predict that the human adds other ingredients (418) and then puts the chicken and ingredients in an oven (420) for cooking. Likewise, for each aspect, e.g., location, action, intent, and context, a prediction can be made in accordance with the sequence of next actions at times in the future, e.g., predicted next states (Sy₁, Sy₂, Syₛ . . . ). In some cases, the long term forecast model 516 can utilize the short term forecast model 502 for its first predicted next state. For each predicted next state, each aspect is encoded by a variational long term autoencoder 526, e.g., a distributional representation of a latent next state is generated. Thus, in the example of FIG. 5, for each predicted next state (Sy₁, Sy₂, Syₛ . . . ), the long term autoencoder 526 generates a latent next state that can be a vector including each aspect (Sy̅₁(ō, ā, ī, ē)).

Each of the compatibility detectors 524a, 524b, 524c, and 524d receives the predicted next value of the latent first state (Sō, Sā, Sī, Sē) from the corresponding predictor 520a, 520b, 520c, 520d. Additionally, each compatibility detector receives the latent next state of the context data 504 from the long term autoencoder 526. Each compatibility detector utilizes an energy function to compare the corresponding aspect of the latent next state and the predicted next value of the latent first state by determining a distance between the latent next state and the predicted next value of the latent first state. In some cases, the energy function can be: Eₙ=argminy (Syₙ, Sy̅ₙ). In other cases, the energy function can be built around Bayesian update and localized sampling on the latent space. The construction of the energy function in the context of the application can be static, dynamically updated, or intelligently derived from context of any electronic device 206 or in the network or any variable that can contribute to the scenario, e.g., an environmental context.

Referring back to our cooking scenario illustrated in FIG. 4, during the cooking steps (412, 414, 418, 420) something unexpected happens, e.g., the doorbell rings and the human goes (416) to the door (an action not in our predicted sequence of actions). The compatibility detector by comparing the latent next state and the predicted next value of the latent first state, detects a change (a context change) in the sequence of events (e.g., was this a predicted next action/intent?). In this example, it would be a context change because going to the door (416) is not one of the predicted steps in cooking our meal. In order to know if the ML models running on one or more of the electronic devices 206 in the smart home environment 200 need to be changed, however, a determination needs to be made if is this context change is a meaningful context change, e.g., is my human going to abandon his intent of cooking the meal? Or is this a temporary change in which the human will resume the cooking steps soon?

The context change detector 522 can determine when the context change is a meaningful context change. A context change, as indicated by the compatibility detector, does not necessarily indicate a meaningful context change, e.g., the human is changing his intent. For example, the human can be distracted and temporarily attend to another task. The context change detector 522 receives a resulting value from the comparison of the compatibility detector for each aspect of the human experience. Utilizing a combination of the resulting values, the context change detector 522 compares this combination value to a threshold value. When the comparison value is small, e.g., the values are close together, and below a threshold value, this can indicate that the two values are compatible. When the two values are compatible, a context change is not a meaningful context change. However, when the comparison value is large and equal to or above the threshold value, e.g., the values are not close together, an incompatibility between the next latent state and the predicted next value of the latent first state exists. The incompatibility can indicate a meaningful context change. The threshold value can be static, e.g., a constant value, dynamically updated, or derived from the scenario.

Again, referring back to our cooking scenario, the person 204 goes (416) to the door after hearing the doorbell, opens the door, and notices that a package has been delivered. He then brings the package into the house and goes back to the kitchen to resume cooking. The electronic devices 206 detect that the human is still in the house, goes back into the kitchen, and proceeds to adding ingredients (418) within a short amount of time, e.g., five minutes. A meaningful context change has not occurred. However, if the person goes to the door, opens the door, learns that a child needs his help, and rushes out the door, the electronic devices 206 detect that the human is no longer in the house and does not go to the next predicted action, e.g., add ingredients (418) in a reasonable amount of time, the context change detector 522 can determine that a meaningful context change has occurred.

After the context change detector 522 determines that a meaningful context change has occurred, the context change detector 522 can generate a notification to a model swapping engine to change a machine language model running on one or more of the electronic devices 206. In addition, depending on the context, the context change system can switch on or switch off one or more of the electronic devices 206. For example, in the cooking scenario, when the person rushes out the door to help the child, any of the appliances having smart devices, such as an oven, for example, can then be switched off.

FIG. 6 illustrates a process flow of a computer implemented method to detect a meaningful context change in a human experience in accordance with one embodiment. Method 600 can be carried out by context change system as described with respect to FIG. 5. Method 600 receives (602) context data from an electronic device, the context data describing one or more aspects of a human experience, wherein the aspects comprise an action and an intent. Method 600 further predicts (604) a next action and a next intent based on the context data. Method 600 further generates (606), by a distributional representation, for each of the next action, the next intent and other aspects, a latent first state. Method 600 further predicts (608), by a predictor, a next value of the latent first state for each latent first state. Method 600 compares (610) a latent next state and the predicted next value of the latent first state for each latent first state by determining a distance between the latent next state and the predicted next value of the latent first state. Method 600 determines (612) a meaningful context change in a human experience when the distance is greater than a threshold.

According to other applications of the improved detection of behavior from multi-variable data described with respect to FIG. 1, a method and a behavior analysis system to detect abnormal behavior of an electronic device are provided. That is, the process for improved detection of behavior from multi-variable data as detailed in FIG. 1 can be utilized for attack detection of an electronic device.

In conventional computers and computer networks, an attack refers to various attempts to achieve unauthorized access to technological resources. An attacker may attempt to access data, functions, or other restricted areas of a susceptible computing system without authorization. For example, the attacker may attempt to corrupt parts of the susceptible computing system, which may appear benign in nature, or to overwhelm public operations by forcing these operations to be called excessively. Thus, an attacker can use many types of attacks with different goals in mind to attack a technological resource.

A computing system's architecture includes several layers such as the hardware layer, the operating system layer, the network layer, the user layer, etc. For example, the hardware layer (e.g., the electronic device layer) may include an integrated circuit (IC) manufactured on a chip which may be in the form of a system on a chip (SoC). When there is an attack, or a malicious event, there are typically indicators of compromise within the computing system. These indicators of compromise on the computing system can be measured by any or all of these layers. The relevance of the indicator of compromise is typically measured by the likelihood that the indicator of compromise is associated with the attack or malicious event.

A method and a behavior analysis system to detect abnormal behavior of an electronic device is described herein. Through the described method and system, an attack on the electronic device can be detected by determining the behavior of the electronic device using collected telemetry data. As mentioned above, when an attack on an electronic device occurs, there are typically indicators of compromise. Through the collected telemetry data and behavior analysis of the collected data performed by the method, known attack patterns can be detected as well as novel forms of attack patterns. Furthermore, abnormal detected behavior can be fed back into the system for training so that the behavior can be properly detected in the future. In some cases, the behavior analysis system can be trained to recognize known behaviors of an application, e.g., an App, running on the electronic device. By recognizing known behaviors, the behavior analysis system can detect unknown behaviors of the App which could be an attack on the electronic device or could be a new normal behavior that has not previously been detected.

The electronic device can be any electronic device that includes electronic circuitry and can include multiple electronic devices. In some cases, and for exemplary purposes in this disclosure, the electronic device is a processing unit such as a microprocessor embodied as a SoC or a chiplet. An SoC can be a single integrated circuit (IC) that comprises the functions of several integrated circuits (ICs), e.g., a CPU, I/O controller, and a GPU. In certain implementations, the electronic device can include a smart card, a smart phone, a laptop computer, i.e., systems that utilize electronic circuitry. Telemetry data representing the state of the electronic device can be collected by various means. Dedicated security sensors distributed throughout the microprocessor can be one means of collecting the telemetry data. Security sensors can include sensors taking direct measurement or can be modeled, estimated, and/or virtual sensors providing a sensed value based on other values available in the system.

In an implementation, the behavior analysis system can include analytics processing circuitry that receives telemetry data relating to the electronic device. The analytics processing circuitry can exist on the same chip as the electronic device, or the analytics processing circuitry can operate independent of the IC's functional circuity. Components of the analytics processing circuitry can include a processing unit such as a microprocessor or a component of a microcontroller such as a memory protection unit (MPU). In some cases, the analytics processing circuitry is ‘virtual circuitry’ such that the method is executed in a cloud environment on one or more host computing systems.

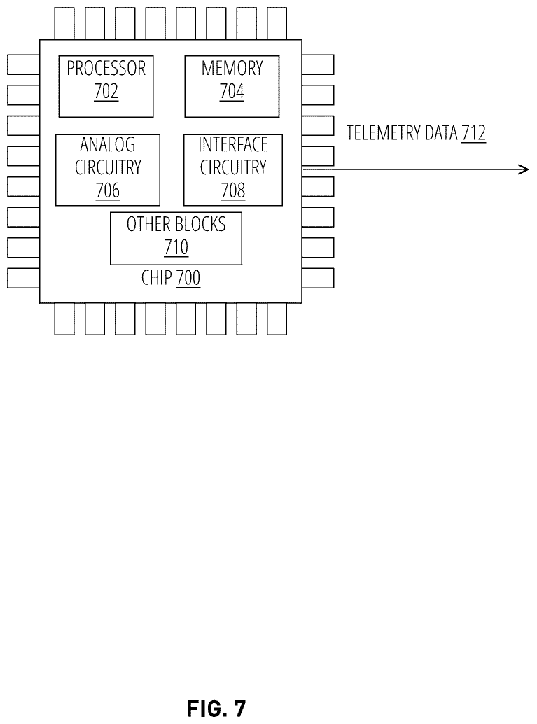

FIG. 7 illustrates a simplified view of an IC with various circuit blocks. Referring to FIG. 1, a chip 700 implementing an IC, e.g., a microprocessor, can include a plurality of different circuit blocks and sub-blocks, including, but not limited to, a processing unit 702, memory 704, analog circuitry 706, interface circuitry 708 (e.g., providing network and other communications interface(s)), and other blocks 710. Telemetry data 712 can be collected from the different circuit blocks on the chip 700.

In some cases, the telemetry data can be low-level telemetry data such as microprocessor interrupt data, performance monitoring data, memory access data, prefetcher data, etc. In other cases, the telemetry data can be communication data between the circuit blocks on the chip 700. For example, referring to FIG. 7, the telemetry data can be an input to the processing unit 702, an input to memory 704, or other telemetry data from other blocks 710 on the chip 700.

The collected telemetry data 712 exists in a first state. In some cases, the telemetry data 712 can be a stream of data, e.g., a time series of data, X_{t₀}=(x_₁,x_₂, . . . , x_ₙ)_{t₀}, in the first state. In addition, the telemetry data can include the next state of the same telemetry data collected at a time after the time the telemetry data in the first state was collected. The next state can also include a stream of data, e.g., time series of the data Y_{t₁}=(y__{1,} y_₂, . . . , y_ₙ)_{t₁}, in the next state. By determining a compatibility of the first state and the next state of the data, a normal/abnormal behavior of the electronic device can be ascertained.

While one chip 700 is illustrated in FIG. 7, the telemetry data 712 can be collected from multiple chips, e.g., processing units. The multiple chips can be located in adjacent systems, for example.

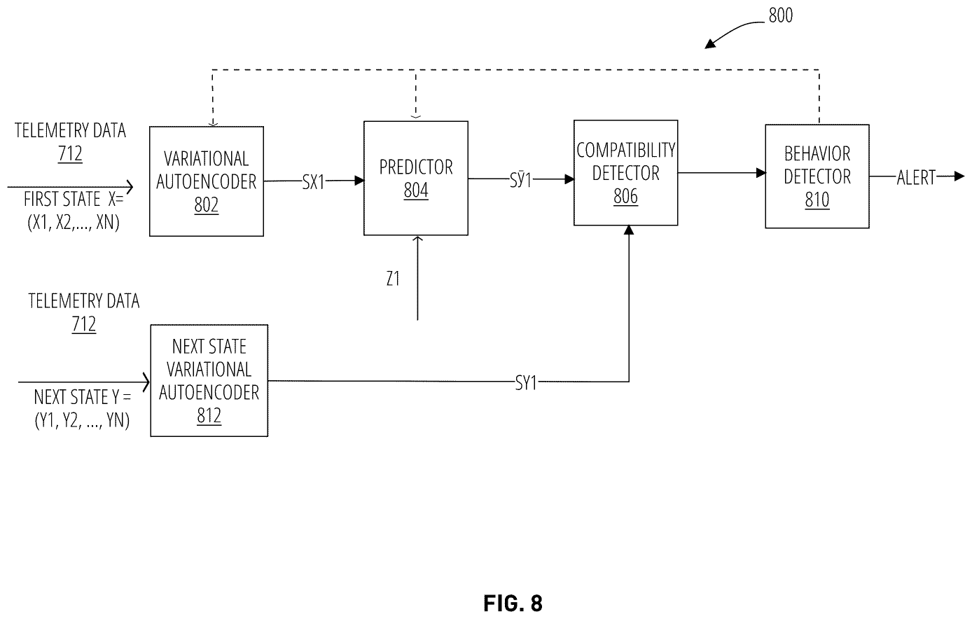

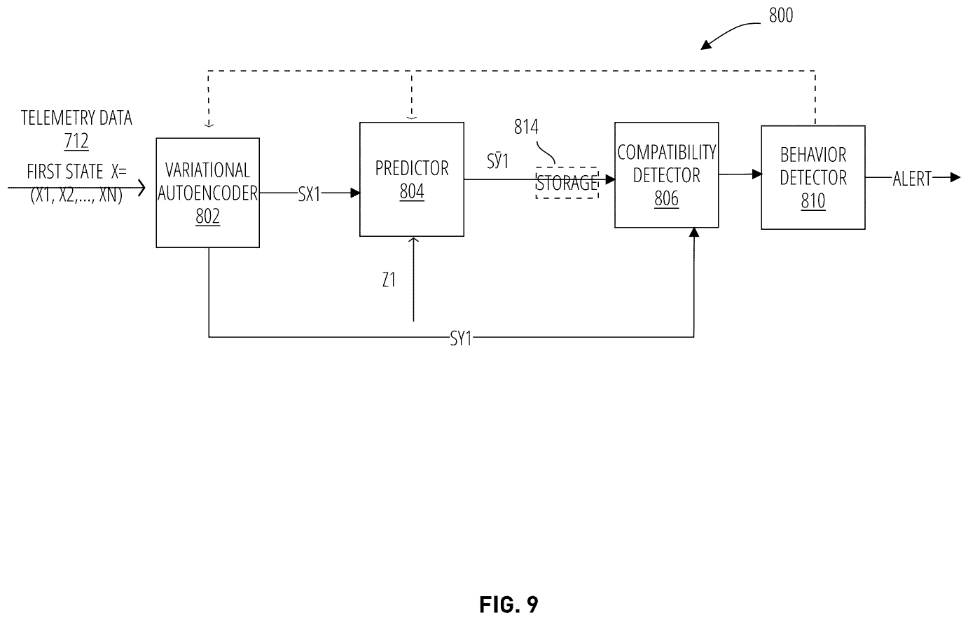

FIG. 8 illustrates an example implementation of a behavior analysis system architecture; and FIG. 9 illustrates a second example implementation of a behavior analysis system architecture. Referring to FIG. 8, a behavior analysis system architecture 800 can include one or more variational autoencoders, e.g., variational autoencoder 802 and next state variational autoencoder 812, a predictor 804, a compatibility detector 806, and a behavior detector 810. As mentioned above, the behavior analysis system (and analytics processing circuitry based on architecture 800) can be embodied using one or more processing units such as a microprocessor or a component of a microcontroller such as a memory protection unit (MPU). In some cases, the behavior analysis system can be implemented on chip 700 along with the IC being analyzed.

Variational autoencoders include a type of unsupervised generative learning technique used in machine learning and are capable of finding ‘normalized’ latent space representations in raw input data using neural networks. By reducing the dimensionality of the input data, variational autoencoders can find latent space representations. Variational autoencoder 802 and next state variational autoencoder 812 are deterministic variational autoencoders that take in the telemetry data 812 as input and output a latent representation (Sx1 and Sy1, respectively) of the input data. While variational autoencoders are referenced throughout the disclosure, they are one example of generating a distributional representation of a latent state. Other energy-based methods can be used to generate a distributional representation of a latent state.

Variational autoencoder 802 and next state variational autoencoder 812, each includes a high-level model that has been trained to identify certain patterns of the collected time series of security telemetry data. For example, in some cases, the high-level model can be trained to detect a normal behavior, or an abnormal behavior of the electronic device based on the identified patterns in the collected telemetry data. In other cases, the high-level model can be obtained from a library of models trained on various aspects of data such as for specific electronic devices or from specific vendors. Variational autoencoder 802 generates as its output a latent first state (Sx1). Next state variational autoencoder 812 generates as its output a latent next state (Sy1). In some cases, the functionality of next state variational autoencoder 812, e.g., to generate a latent next state Sy1, can be performed by variational autoencoder 802. For example, referring to FIG. 9, the functionality of the next state variational autoencoder 812 is also implemented by variational autoencoder 802 in subsequent operations through the inclusion of storage component 814, enabling variational autoencoder 812 to be omitted. The storage component 814 retains the value of the latent next state Sy1 until the next Sxn is ready.

The predictor 804 receives the output of variational autoencoder 802 to receive as an input the latent first state (Sx1). Predictor 804 is trained to detect, or predict, the next state of the latent first state and can include one or more processing units and storage to support artificial intelligence, machine learning, and/or deep learning processes. The predictor 804 includes a high-level machine learning model that has been trained on potential future latent states of the latent first state (Sx1). For example, there may be two potential future states or many potential futures states which the model is trained to predict. The high-level machine learning model can be applied to the latent first state to generate as an output a next value of the latent first state (Sy̅1).

In some cases, the high-level machine learning model of the predictor 804 includes a latent variable energy-based prediction model. Energy-based models are generative models that can learn an underlying data distribution by analyzing a dataset. The latent variable energy-based model evaluates the degree of compatibility between the latent next state Sy1 and the predicted next value of the latent first state Sx1. In this context, the role of latent variable energy-based model of the predictor 804 is predicting the next value of the latent first state Sx1. In order to do this prediction, the predictor 804 can utilize a latent variable, Zₙ, that provides auxiliary information that cannot be extracted from the latent first state. For the high-level machine learning model of predictor 804, the latent variable can represent a possible future state when the latent first state has multiple possible futures. Then, when something unusual occurs, e.g., an unpredicted event, or sequence of unpredicted events, such as an attack on the electronic device, the predictor 804 would not be able to properly predict the next value of the latent first state Sx1. Thus, the compatibility detector 806 will be able to detect the unpredicted event or sequence of events.

The latent variable, Zₙ, enables the latent variable energy-based model to handle multiple predictions and is identified during the training phase. For example, if an App is running on the electronic device, its execution can create an ensemble of potential future states of the telemetry data. To avoid having to train the predictor 804 with a generative model, the latent variable Zₙ can be defined by running an ‘argmin’function such as ̌z=argminz∈Z Ew (x, y, z).

The compatibility detector 806 receives the predicted next value of the latent first state from the predictor 804. Additionally, the compatibility detector 806 receives the latent next state of the telemetry data 712 from next state variational autoencoder 812. The compatibility detector 806 utilizes an energy function to compare the next state and the predicted next value of the latent first state by determining a distance between the next state (actual value) and the predicted next value of the latent first state. In some cases, the energy function can be: Eₙ=argminy (Syₙ, Sy̅ₙ). In other cases, the energy function can be built around Bayesian update and localized sampling on the latent space. The construction of the energy function in the context of the application can be static, dynamically updated, or intelligently derived from context of the electronic device in the network.

Behavior detector 810 receives a resulting value from the comparison of the compatibility detector 806. A resulting value from the comparison that is small, e.g., the values are close to each other, and below a threshold value, can indicate that the two values are compatible. When the two values are compatible, a normal behavior of the electronic device is indicated. However, when the resulting value from the comparison is large and equal to or above the threshold value, e.g., the values are not close together, an incompatibility between the next state and the predicted next value of the latent first state exists. The incompatibility can indicate that the electronic device is behaving abnormally. The threshold value can be static, e.g., a constant value, dynamically updated, or derived from the context. The inputs for the context, in this regard, can be obtained from the behavior of the electronic device or influenced by neighboring devices in the same network or associated networks.

The behavior detector 810 can generate an alert in real time when the abnormal behavior indicates an attack of the electronic device. Abnormal behavior, as indicated by the compatibility detector, does not necessarily indicate an attack on the electronic device, e.g., it can be a false positive. Further analysis may be needed to validate if the abnormal behavior is an attack or not. The alert can include information from the behavior analysis such as the predicted next value of the latent first state and the high-level model (of the predictor and/or the variational autoencoder) to indicate to other electronic devices a known attack pattern. The behavior detector 810 can also store information in memory 804 from the behavior analysis system such as the telemetry data 712 that was determined to indicate abnormal behavior, the high-level models utilized by the variational autoencoder(s) and/or the predictor 804, etc. The alert can be received by adjacent systems and/or cores as well as by systems in a virtual environment, such as the cloud, for example.

In some cases, the detected abnormal behavior and/or detected normal behavior can be fed back to the predictor 804 and/or the compatibility detector 806 to tune the high-level models used in variational autoencoder 802 and the predictor 804, respectively. Additionally, in some cases, a service component can be enabled to distribute known attack patterns described by the abnormal and normal behaviors and the corresponding high-level models to other processing units so that the behaviors, e.g., a behavior indicating an attack, can be detected in real-time.

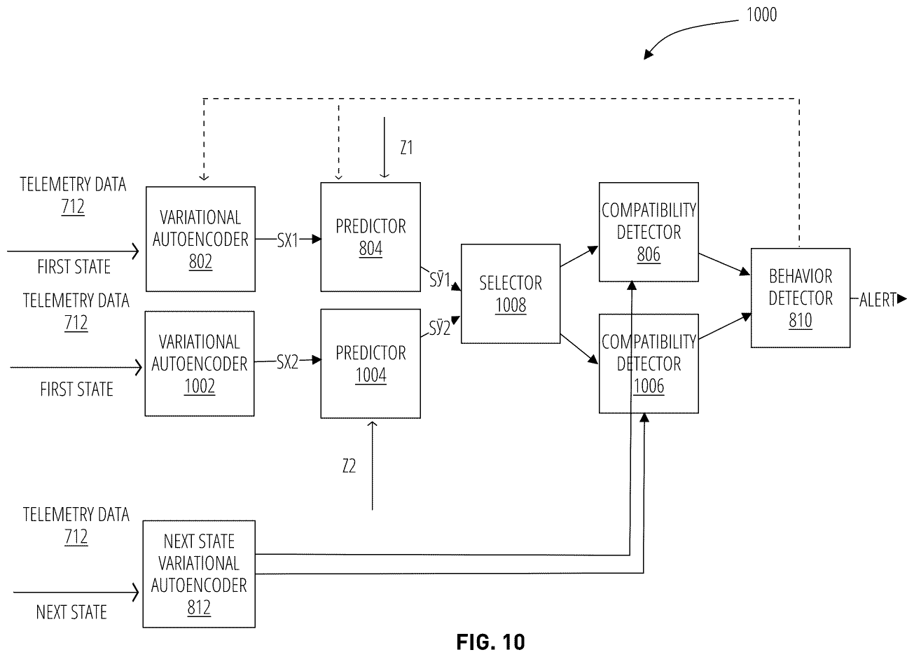

FIG. 10 illustrates a further example implementation of a behavior analysis system architecture. Referring to FIG. 10, an operating environment 1000 of the behavior analysis system can include multiple variational autoencoders and multiple predictors, each variational autoencoder coupled to a corresponding predictor. Referring to FIG. 10, the same telemetry data 712 is input to multiple variational autoencoders, e.g., variational autoencoder 802 and variational autoencoder 1002, and processed by the respective variational autoencoder and predictor in parallel. Variational autoencoder 802 is coupled to predictor 804 and variational autoencoder 1002 is coupled to predictor 1004. While two variational autoencoders are depicted in FIG. 10, multiple variational autoencoders can include any number of variational autoencoders greater than one. Variational autoencoder 802 and variational autoencoder 1002 each can include a high-level model that is trained to detect a different pattern in the first state so that multiple next values of the latent first state are predicted. For example, variational autoencoder 802 can be trained to detect normal behaviors while variational autoencoder 1002 can be trained to detect known abnormal behavior (e.g., behavior known to be attack behavior). Similar to the example implementation of FIG. 8, the behavior analysis system (and analytics processing circuitry based on architecture 1000) can be embodied using one or more processing units such as a microprocessor or a component of a microcontroller such as a memory protection unit (MPU). In some cases, the behavior analysis system can be implemented on chip 700 along with the IC being analyzed.

In addition, similarly to the example implementation of FIG. 8, variational autoencoder 812 receives the next state of the telemetry data 712 and generates as its output a latent next state (Sy1). Variational autoencoder 812 could be trained similarly to variational autoencoders 802 or variational autoencoder 1002, however, variational autoencoder 812 can also be trained differently. For example, variational autoencoder 812 can include a different architecture or have different parameters.

Selector 1008 can be included in the behavior analysis system to select one or more predicted next values of the latent first state to be input into compatibility detector 806 that performs a comparison utilizing the energy function. Only the selected one or more predicted next values of the latent first state are then compared by the compatibility detector 806. For example, the selector 1008 may choose the most relevant high-level model, e.g., a high-level model from a library or a high-level model that predicts attacks, normal behaviors, etc. as the same telemetry data is input into multiple variational autoencoder/predictor pairs. The unchosen predictions could go to another system to test and compare the predicted values from the high-level model to other data from other high-level models, for example. The selected predicted next values of the latent first state is then input into a corresponding compatibility detector 806, 1006 and then to the behavior detector 810 as described above.

In some cases when the functionality of the next state variational autoencoder 812 is performed by each of variational autoencoder 802 and variational autoencoder 1002, the functionality of selector 1008 and the necessary hardware associated with the selector 1008, as well as the next state variational autoencoder 812 can be eliminated. Whether or not selector 1008 is used depends on the number of compatibility detectors 806, 1006 in the operating environment 1000. If there are fewer compatibility detectors 806, 1006 than variational autoencoders 802, 1002, a selector 1008 is needed.

Referring to the embodiment in FIG. 10, the next state variational autoencoder 812 is shared by compatibility detector 806 and compatibility detector 1006. In this case, each predictor 804, 1004 predicts the next state of the latent first state, respectively, and translates the latent first state of the respective variational autoencoder, 802, 1002 to the latent next state of the next state variational autoencoder 812. By comparing the latent first state to the predicted next state of the latent first state in the respective predictor, e.g., predictor 804 or predictor 1004, the translation step can be eliminated and enable the predictor and respective variational autoencoder, e.g., variational autoencoder 802 and variational autoencoder 1002, to be trained together to identify the most useful latent variables for their respective pattern detection. Therefore, each predictor/variational autoencoder pair can work together with their own set of latent variables that do not need to be related in any way to any other variational autoencoder or predictor.

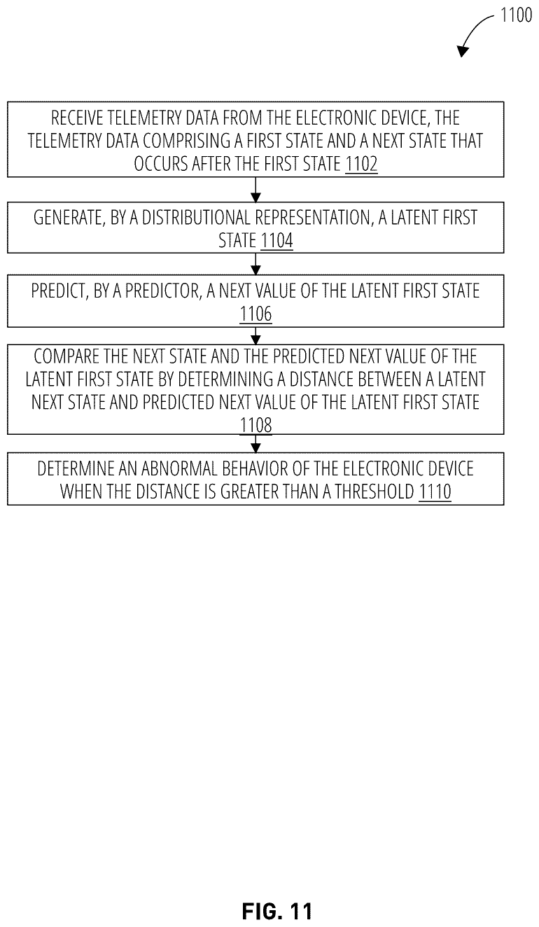

FIG. 11 illustrates a process flow of a computer implemented method to detect abnormal behavior of an electronic device in accordance with one embodiment. Method 1100 can be carried out by a system implementing behavior analysis system architecture as described with respect to FIGS. 8-10. The behavior analysis system can include one or more variational autoencoders that can generate a latent first state of telemetry data and a latent next state of the same telemetry data, predictors 804, 1004, selector 1008, compatibility detectors 806, 1006 and a behavior detector 810. Each of variational autoencoders and the predictors can include a high-level model that is trained to detect particular behaviors of the telemetry data.

Method 1100 receives (1102) telemetry data from the electronic device, the telemetry data comprising a first state and a next state that occurs after the first state. In some cases, the telemetry data can be received from circuit blocks on a chip 700 as described above. In some cases, telemetry data can be a stream of collected telemetry data from any aspect of the electronic device.

Method 1100 further generates (1104), by a distributional representation such as a variational autoencoder, a latent first state. Training can be performed on one or more high level models (e.g., one per variational autoencoder) to detect different aspects of the telemetry data 712. In some cases, a first high level model can be trained to detect certain patterns of data that indicate a normal behavior of the electronic device. In other cases, a second high-level model can be trained to detect certain patterns of data that indicate abnormal behavior, including known attack behavior. A next state variational autoencoder can be trained to detect patterns in the next state of the telemetry data 712.

Method 1100 further predicts (1106), by a predictor, a next value of the latent first state. The predicting includes applying a high-level model to the latent first state to obtain a next value of the latent first state. The high-level model can be a latent variable energy-based model that evaluates a compatibility between the latent first state and the next value of the latent first state. In some cases, a latent variable is utilized to parameterize the set of possible relationships between the latent first state and the next value of the latent first state.

Method 1100 further compares (1108) the next state and the predicted next value of the latent first state by determining a distance between a latent next state and predicted next value of the latent first state. An energy function, such as Eₙ=argminy (Syₙ, Sy̅ₙ), can be utilized to perform the comparing.

Method 1100 determines (1110) an abnormal behavior of the electronic device when the distance is greater than a threshold. Having a distance value greater than the threshold indicates that an incompatibility between the next state and the predicted next value of the latent first state exists. In an embodiment, responsive to a determination that the abnormal behavior indicates an attack on the electronic device, an alert can be issued as a warning to other electronic devices or systems that an attack has occurred. The alert can include information of the attack so that the other electronic devices can potentially predict the attack in the future.

In an embodiment, when an abnormal behavior has been determined, the behavior detector 810 can then determine whether the abnormal behavior is a false positive, e.g., the abnormal behavior is really a normal behavior that the predictor has not been trained to detect. Once the behavior detector 810 determines a false positive, the predicted next value of the latent first state is fed back to the predictor 804 to train the higher-level model with that value. This value can be treated as a new latent variable.

For example, if the high-level model, e.g., of predictor 804, has been trained to detect normal behavior of an application on the electronic device and if the energy function reports a distance between the next state and the predicted next value of the latent first state, this result indicates that the application is not behaving in a known way. However, this indication does not always mean 100% of the time there is an attack on the system. The determined abnormal behavior can be a false positive. Thus, the behavior analysis system is updated to indicate that that the resulting abnormal was not a true attack, but a “new” normal behavior. To avoid the abnormal behavior finding with the same telemetry data in the future, a new predicted next value of the latent first state, e.g., a new latent variable Z, is deployed to the predictor 804 so that the predictor 804 considers the same telemetry data as a normal behavior for prediction in the future.

Similarly, if the high-level model of predictor 804 has been trained to detect a type of cybersecurity attacks, and if the energy function reports a distance between the next state and the predicted next value of the latent first state, this result indicates the attack is not behaving as expected. In this case, the abnormal behavior might not be a new behavior for an attack. This case can be defined as a false negative.

Although the subject matter has been described in language specific to structural features and/or acts, it is to be understood that the subject matter defined in the appended claims is not necessarily limited to the specific features or acts described above. Rather, the specific features and acts described above are disclosed as examples, implementing the claims and other equivalent features and acts; they are intended to be within the scope of the claims.

What is claimed is:

1. A computer-implemented method for controlling operation of one or more electronic devices based on detection of a meaningful context change in context data describing a human experience, the context data comprising data collected by the one or more electronic devices during performance of a task involving a series of steps, the method comprising:
receiving context data from one or more electronic devices, the context data describing aspects of the human experience, wherein the aspects comprise an action and an intent;
predicting a next action and a next intent related to the task based on the context data;
generating, by a distributional representation, for the predicted next action, the predicted next intent and one or more further aspects, a corresponding latent first state;
predicting, by a predictor, a next value of the latent first state for each latent first state;
comparing a latent next state and the predicted next value of the latent first state for each latent first state by determining a distance between the latent next state and the predicted next value of the latent first state;
determining a meaningful context change in the performance of the task when the distance is greater than a threshold, wherein the meaningful context change distinguishes a temporary change of intent and context from a change of intent and context for which a machine learning model running on at least one of the electronic devices is to be changed; and,
in response to determining the meaningful context change, changing a machine learning model running on at least one of the electronic devices.

2. The method of claim 1, wherein the generating the latent first state is performed using a first high-level model trained to detect a pattern in each aspect.

3. The method of claim 1, wherein the predicting a next value of the latent first state for each latent first state includes applying a second high-level model to each latent first state.

4. The method of claim 3, wherein the second high-level model is a latent variable energy-based model.

5. The method of claim 1, wherein the one or more electronic devices are a plurality of connected electronic devices.

6. The method of claim 1 wherein changing the machine learning model comprises:
replacing the machine learning model with a different machine learning model.

7. The method of claim 1, further comprising switching on or switching off one or more of the electronic devices based on the meaningful context change.

8. The method of claim 1, wherein the one or more further aspects include location and context.

9. The method of claim 1, further comprising predicting a sequence of next actions and for each next action of the sequence of next actions generating the latent next state wherein the latent next state includes a next state for each aspect.

10. The method of claim 1, wherein the distributional representation is a variational autoencoder.

11. The method of claim 1, wherein the comparing is performed using an energy function.

12. The method of claim 11, wherein the energy function is Eₙ=argminy (Syₙ, Sy̅ₙ) wherein Syₙ is the latent next state and Sy̅ₙ is the next value of the latent first state.

13. A system to detect a meaningful context change in a human experience, comprising:
one or more processing units;
a memory; and
interface circuitry, wherein the system is structured as:
a short term forecast model that predicts a next action and a next intent from context data received from one or more electronic devices, the context data describing aspects of the human experience wherein the aspects include the next action and the predicted next intent;
a first variational autoencoder that receives prediction values output from the short term forecast model and generates a latent first state of each aspect;
a predictor that receives output of the first variational autoencoder, wherein the predictor applies a high-level model to the latent first state of each aspect to predict a next value of the latent first state;
a compatibility detector that compares the predicted next value of the latent first state and a latent next state to determine a distance between the latent next state and the predicted next value of the latent first state; and
a context change detector that receives output of the predictor to detect a meaningful context change when the distance is greater than a threshold, wherein the meaningful context change distinguishes a temporary change of intent and context from a change of intent and context for which a machine learning model is to be changed.

14. The system of claim 13, further comprising a long term forecast model that predicts a sequence of next actions and a long term autoencoder, wherein for each next action in the sequence of next actions, the long term autoencoder generates a latent next state that includes a latent next state of each of the aspects.

15. The system of claim 13, wherein the aspects further include location and context.

16. The system of claim 13, wherein each electronic device is one of a personal device or an ambient device.

17. The system of claim 13, further comprising a model swapping engine configured to change a machine learning model running on the one or more of the electronic devices when the meaningful context change corresponds to a change of intent and a context for which the machine learning model is to be changed.

18. The system of claim 13, wherein the first variational autoencoder applies a first high-level model trained to detect a pattern in each aspect and wherein the predictor applies a second high-level model to the latent first state to predict the next value of the latent first state.

19. The system of claim 13, wherein the compatibility detector is configured to compare the latent next state and the predicted next value of the latent first state using an energy function.

20. A non-transitory computer-readable medium storing instructions that, when executed by one or more processors, cause the one or more processors to perform a method for controlling operation of one or more electronic devices based on detection of a meaningful context change in context data describing a human experience, the method comprising:
receiving context data from one or more electronic devices, the context data describing aspects of the human experience, wherein the aspects comprise an action and an intent;
predicting a next action and a next intent related to a task based on the context data;
generating, by a distributional representation, for the predicted next action, the predicted next intent and one or more further aspects, a corresponding latent first state;
predicting, by a predictor, a next value of the latent first state for each latent first state;
comparing a latent next state and the predicted next value of the latent first state for each latent first state by determining a distance between the latent next state and the predicted next value of the latent first state;
determining a meaningful context change in the performance of the task when the distance is greater than a threshold, wherein the meaningful context change distinguishes a temporary change of intent and context from a change of intent and context for which a machine learning model running on at least one of the electronic devices is to be changed; and
in response to determining the meaningful context change, changing the machine learning model running on at least one of the electronic devices.
